(19) United States
(12) Patent Application Publication
(10) Pub. No.: US 2011/0112797 A1
(43) Pub. Date: May 12, 2011

(54) Efficiency monitoring of a compressor

(76) Inventors: Andreas Nühse, Bochum (DE); Georg Winkes, Kaarst (DE)

(21) Appl. No.: 12/989,434

(22) PCT Filed: Apr. 23, 2009
(86) PCT No.: PCT/EP2009/054911

§ 371 Date: Jan. 5, 2011

(30) Foreign Application Priority Data
Apr. 28, 2008 (DE) 10 2008 021 102.8

(51) Int. Cl. G06F 15/00

(52) U.S. Cl. 702/182

(57) ABSTRACT

A method for monitoring the efficiency of a compressor is provided. A mass flow, an entry pressure, an exit pressure, an entry temperature, and an exit temperature of the process medium are all determined and a performance factor is ascertained. At the inlet of each stage, a stage entry temperature and a stage entry pressure are directly or indirectly measured as measurement parameters. At the outlet of each stage, a stage exit temperature and a stage exit pressure are directly or indirectly measured as measurement parameters. Each stage is assigned a module which calculates a stage efficiency as a performance factor from the measurement parameters using a calculation means.

### CROSS REFERENCE TO RELATED APPLICATIONS

This application is the US National Stage of International Application No. PCT/EP2009/054911, filed Apr. 23, 2009 and claims the benefit thereof. The International Application claims the benefits of Getman application No. 10 2008 021 102.8 DE filed Apr. 28, 2008. All of the applications are incorporated by reference herein in their entirety.

### FIELD OF INVENTION

The invention relates to a method for monitoring the efficiency of an at least two stage compressor, an intermediate cooling stage being provided between the stages, during the compression of a process medium, in the case of which monitoring
a flow rate through the compressor,
an entry pressure of the drawn-in process medium,
an exit pressure of the compressed process medium,
an entry temperature of the drawn-in process medium, and
an exit temperature of the compressed process medium
   are determined as parameters, and calculation means are used to ascertain a performance factor from the parameters.

### BACKGROUND OF INVENTION

The monitoring of turbocompressors continuously in operation essentially presently comprises the following variables: shaft oscillation and shaft position, bearing temperatures and other variables in the case of which it is possible to infer the state of a component or of a part of a system for a single measurement. With regard to economic operation of a compressor, the particular efficiency at which the compression operation proceeds is of particular interest. In order to determine this, there is a need for a plurality of measurements whose signals are combined with one another. The result of this calculation represents a measure of the efficiency of the compressor (for example polytropic or isentropic efficiency). In addition, sufficiently accurate determinations of efficiency also permit conclusions to be drawn in relation to the technical state of the compressor, and whether said state need be corrected.

EP 1 488 295 B1 has already described an attempt to track the performance of an industrial device in the case of which the gas throughflow through a compressor, the pressure of the entering gas and the pressure of the exiting gas, as well as the temperature of the coolant from the inteonediate cooling stage are used in order to determine a performance factor. Subsequently, the performance factor is used to calculate an estimated efficiency. In addition, it is known from US 2006/0155514 A1 to implement the performance of a compressor by measuring a few operating parameters and using them as a basis to estimate the energy consumption, this estimate being compared with the results from a theoretical model, and conclusions thereby being drawn on the state of the system. Both of the abovementioned methods peunit an in each case only coarse estimate of the loss of efficiency, since the accuracy of the estimate is severely limited, in particular owing to the multidimensionality of the operating parameters.

Documents EP 0 366 219 A2 and U.S. Pat. No. 7,094,019 B1 are respectively concerned with the approach to the pump limit of a turboconverter by means of close-loop control measures. The proposed methods offer no suitable possibility to employ the operating range for optimum utilization of the pump limit for a turbocompressor with intermediate cooling.

In summary, the determination of the loss of efficiency is relatively problematic because, in particular, the efficiency is always a function of the operating point that is determined by a multiplicity of influencing factors of a multidimensional parameter field, and because changes therefore always have to be related to the same operating conditions in order to be able to pronounce on the accuracy required.

### SUMMARY OF INVENTION

The invention is therefore based on the object of deter lining the efficiency of a compressor, in particular a turbocompressor, accurately in such a way that it is possible to pronounce on the absolute loss of efficiency of the system while it is operating.

A method having the features set forth in the claims for the achievement of the object according to the invention is proposed. The subclaims respectively referred back include advantageous developments of the invention.

The measurement of the pressure and of the temperature at the entry and at the exit of each individual stage enables a stage efficiency to be ascertained even when an intermediate cooling stage is provided between the stages. By contrast with the prior art, the invention can be used to represent the efficiency with a resolution that is accurate by stage, and the influences of the intake temperature or the entry temperature into each individual stage are taken into account.

Even if frequent reference is subsequently made to the efficiency by means of the reference symbol, the efficiency is not specified by the polytropic efficiency, but rather it can be any form of the efficiency, should there be no stipulation of a clear restriction in some other way.

In the inventive method, the compressor can have virtually any desired number of stages. Realistic arrangements mostly have a number of stages of up to eight.

In particular, a temperature of a coolant of an intermediate cooling stage cannot, as in the prior art, deliver sufficiently accurate knowledge relating to the entry temperature into a subsequent stage, let alone enable conclusions to be drawn on variations in efficiency.

If, in the case of an inventive method, there should be no intermediate cooling stage between two stages, the exit temperature from the stage situated upstream can be set equal to the entry temperature into the stage situated downstream.

In the first stage, is it possible, if appropriate, to dispense with a measurement of the entry pressure when the latter is equal to the ambient pressure. Consequently, the measurement of the ambient pressure takes the place of the measurement of the entry pressure in the first stage.

The modules are preferably present as program parts in a computer that obtains the required data either directly from the machine controller or the compressor regulator, or has dedicated input channels for the measured variables or has recourse to stored measured data.

The gas composition can advantageously be determined as an input variable for the calculation by means of the modules, in particular when said gas composition is variable. A manual input, but preferably an automatic acquisition via a continuous gas analysis, can be provided to this end. Particularly in the case of air compressors, it can be advantageous to know the air humidity (relative or absolute) of the drawn-in air in order to be able to improve the accuracy of the calculation.

Exceptionally, it is possible to dispense with a direct measurement of the entry temperature in a stage downstream of an intermediate cooling stage when the recooling temperature is to be regarded as constant, for example because a recooling temperature regulator is provided, for example in the form of a cooling water quantity regulator or regulated air cooler that always ensures the same exit temperature from the intermediate cooling stage despite a possibly varying input temperature. This case corresponds to an indirect measurement of the entry temperature, since a measurement of temperatures in the intermediate cooling stage is required for such an accurate regulation of the recooling temperature.

Assuming an ideal gas, the polytropic efficiency of a stage can be determined via the formula

$${η}_{pol} = \frac{1}{ν} = \frac{{{c}_{p}}^{\overline{\_}}}{R} \cdot \frac{ln \frac{{T}_{a}}{{T}_{e}}}{ln \frac{{p}_{a}}{{p}_{e}}} .$$

Here, nₚₒₗ is the polytropic efficiency of stage n, ν the polytropic ratio, C̅ₚ the specific thermal capacity averaged over the corresponding pressure and temperature ranges, R the ideal gas constant, Ta the exit temperature, Te the entry temperature, Pa the exit pressure and Pe the entry pressure, all these being referred to the respective stage n.

For a higher measure of accuracy, the efficiency can be ascertained by means of a numerical integration of a real gas equation of state of the process gas between the entry state and the exit state in order to determine the polytropic ratio ν. In addition, it is also possible to ascertain an isentropic or isotheimal efficiency.

The ascertained stage efficiency is preferably set in a numerical ratio to a reference stage efficiency, and the result displayed on a display unit. This ratio can, for example, be the result of a division, or be calculated as a percentage efficiency loss, or simply as a difference. In the case of overshooting of a specific limit value of this ratio, a separate automatic indication can be given to the operator, for example as a visual or acoustic alarm.

An advantageous development of the invention provides that there is stored in a memory for each stage a reference stage set of characteristics, from which set an arithmetic logic unit ascertains a reference stage efficiency from the measurement parameters and, for the purpose of forming the ratio, compares said reference stage efficiency with the efficiency in a numerical fashion, as previously explained. Since, depending on the application, it can be too inaccurate to ascertain the reference stage set of characteristics in a completely theoretical fashion for the inventive object, the invention further proposes to determine the reference stage set of characteristics during a calibration operation in the case of which given various guide blade positions and/or rotational speeds of the compressor a pressure-side choke is closed in a stepwise or continuous fashion, from being completely open, until a pump limit is reached. The results of this continuous or pointwise measurement are stored in a memory as points in the reference stage set of characteristics. In order to move from the pointwise measurements to a continuous set of characteristics, interpolations can be carried out between the individual measuring points in order to ascertain intermediate values, and extrapolations in order to ascertain further values. Alternatively, parameters of a theoretical model that has been provided can be adapted to the measured values such that the theoretical model accordingly adapted provides sufficiently accurate reference data for an inventive evaluation of the efficiency ascertained from the measurement parameters.

### BRIEF DESCRIPTION OF THE DRAWINGS

The invention is described in more detail below with reference to drawings for the purpose of explanation with the aid of an exemplary embodiment. For the person skilled in the art, the invention yields further implementation possibilities in addition to this special exemplary embodiment. In the drawing:

FIG. 1 is a schematic of the measurements in accordance with an inventive method,

FIG. 2 is a schematic for ascertaining a reference stage set of characteristics, and

FIG. 3 is a schematic of a reference stage set of characteristics.

### DETAILED DESCRIPTION OF INVENTION

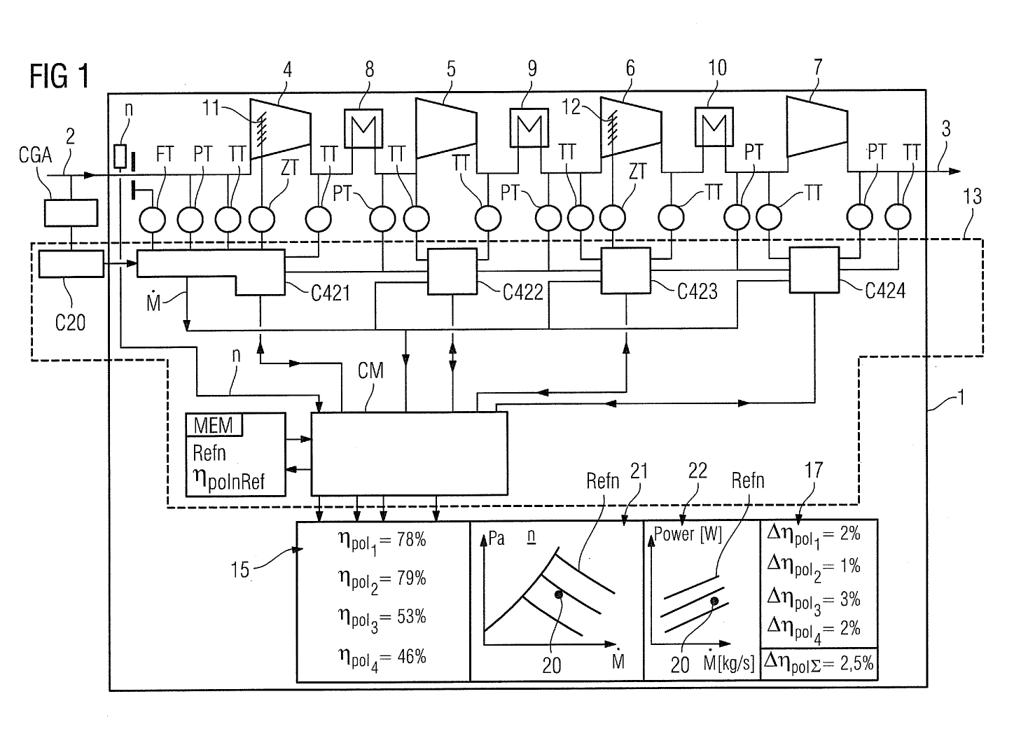

FIG. 1 is a schematic of a compressor 1 to which an inventive method for monitoring the efficiency is applied. A mass flow (measured as \dot{M}) enters the compressor 1 as entry mass flow 2, and exits it as exit mass flow 3. The compressor 1 has four stages 4, 5, 6, 7 (first stage 4 to fourth stage 7 correspondingly from left to right) which are traversed by the entry mass flow 2, an intermediate cooling stage 8, 9, 10 (numbering mutatis mutandis) being provided between the stages in each case.

Before entry into each stage 4, 5, 6, 7, and after exit from each stage 4, 5, 6, 7, in each case the pressure is measured by means of a pressure measuring point PT, and the temperature is measured by means of a temperature measuring point TT. Since, apart from a pressure loss in the intermediate cooling stage 8, 9, 10 that is small and can be understood, the pressure upstream of the intermediate cooling stage 8, 9, 10 and downstream of the intermediate cooling stage 8, 9, 10 is identical, the pressure measurement downstream of the respective stage 4, 5, 6, 7 is combined with the pressure measurement upstream of the downstream stage 5, 6, 7 at a pressure measuring point PT.

The first stage 4 and the third stage 6 are provided with an adjustable inlet guide grid 11, 12 whose position is ascertained by means of a position sensor ZT. At the input of the compressor 1, the entry mass flow 2, which is identical to the exit mass flow 3, is measured by means of a mass flow measurement FT and assigned as measured value to a parameter M. Each stage is assigned a module C421, C422, C423, C424 that carries out calculations relevant to a stage. The individual modules C421 to C424 are designed as software programs and are executed on a computer 13.

A continuous gas analysis unit CGA permanently analyzes the entry mass flow 2 and transmits a measured gas composition C20 to the first module C421. This gas analysis unit is a sensible optional piece of equipment particularly when the composition of the entry mass flow is changeable. Cyclic measurements can also be carried out in this case. The first module uses the mass flow measurement FT and the gas composition C20 to determine the material flow rate or mass flow \dot{M}, and transmits this parameter to the remaining modules C422 to C424. Each of the individual modules C421 to C424 ascertains a polytropic efficiency n_{pol n} from a stage entry temperature Te n (entry temperature for the stage n), the stage exit temperature Ta n, the stage entry pressure Pe n, the stage exit pressure Pa n and the gas composition C20. This polytropic efficiency n_{pol n} is displayed on a display unit 15 for each stage 4, 5, 6, 7. Given virtually ideal states, the calculation is carried out in accordance with the following formula:

$${η}_{pol} = \frac{1}{ν} = \frac{{{c}_{p}}^{\overline{\_}}}{R} \cdot \frac{ln \frac{{T}_{a}}{{T}_{e}}}{ln \frac{{p}_{a}}{{p}_{e}}} .$$

The individual modules C421 to C424 are connected to a central module CM in a fashion exchanging information. The central module CM has access to a memory MEM in which there are stored, inter alia, other reference stage set of characteristics Ref n for the individual stages 4, 5, 6, 7. Using the measurement of the rotational speed n and of the position of the inlet guide grids 11, 12 and the mass flow \dot{M}, the central module CM ascertains from the respective reference stage set of characteristics Ref n an associated stage efficiency n_{pol n}. A ratio 17 between the actual stage efficiency n_{pol n Ref} and the reference stage efficiency n_{pol n Ref} is displayed for each stage on the display unit 15 as difference Δn_{pol n}. Moreover, the reference stage set of characteristics Ref n and the current operating point 20 located therein are displayed graphically in a first frame 21 on the display unit 15 in rapid fashion for each stage 4, 5, 6, 7 in a switchable fashion. In a second frame 22, the power consumption (Y:Power; x:mass flow \dot{M}) is displayed graphically as reference stage set of characteristics Ref n with the current operating point 20.

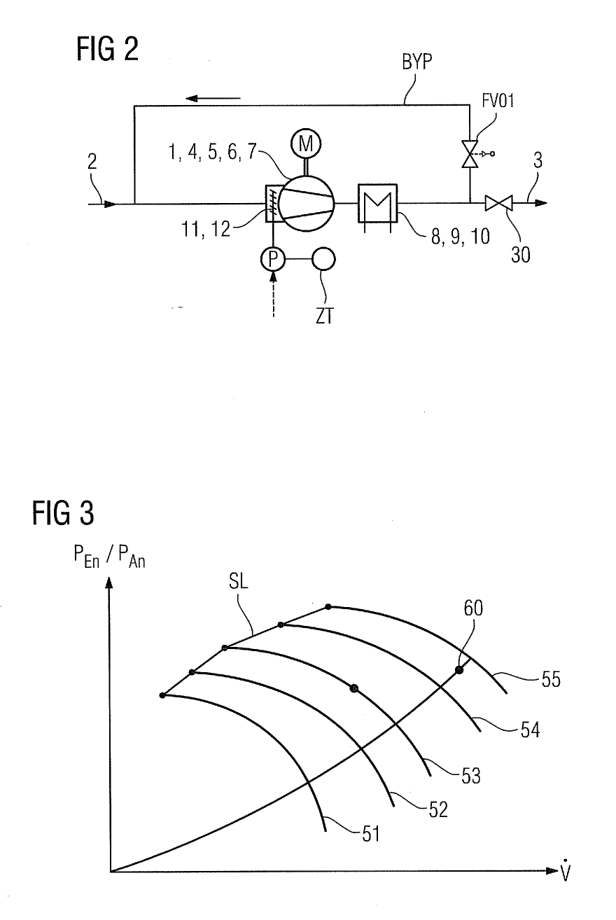

FIG. 2 and FIG. 3 illustrate in simplified fashion the procedure in determining a reference stage set of characteristics Ref n, the compressor 1 and the intermediate cooling stages 8, 9, 10 being reproduced without illustrating the individual stages 4, 5, 6, 7. The compressor 1 is driven by a drive M. It is preferred when starting up the compressor 1 for a shut-off device 30 on the outlet side to be closed, and for a diverter valve FV01 or a choke firstly to be completely open. The diverter valve FV01 arranged in a bypass line BYP is continually closed as the reference stage set of characteristics Ref n is being ascertained until the compressor 1 reaches a pump limit SL. Once the compressor 1 reaches the pump limit SL, the flow in the compressor breaks off, and return flows that can be measured as strong vibrations occur at least in pulses. The values recorded up to this point for the entry temperatures Te n, exit temperatures Tan, entry pressures Pe n and exit pressures Pa n, as well as for the mass flow \dot{M} and the position of the inlet guide grids 11, 12 are used together with the gas composition C20 in order to generate, or at least to correct, the reference set of characteristics for each stage 4, 5, 6, 7. The actual restriction, resulting from the pumping of the entire compressor 1, of the operation for ascertaining the reference set of characteristics for each individual stage restricts the determination of reference data at one end, it being possible, if appropriate, for further data to be taken into account during normal operation as reference data when the reference set of characteristics is generated. The generation of the reference stage set of characteristics Ref n can, on the one hand, proceed from a theoretical prior model that is corrected numerically by means of the measured data, or the measured data can be used, for example by means of regression, to adapt any desired multidimensional function to a reference set of characteristics. Numerical methods that effect optimum adaptation can be applied in the automated acquisition of the reference set of characteristics for each individual stage. It is preferred to use an optimization algorithm that minimizes the residue relating to the measured values by manipulation of a theoretical set of characteristics.

FIG. 3 shows a reference stage set of characteristics Ref n with a pressure ratio (P_{En}/P_{An}) (or dimensionless pressure number) plotted on the Y-axis, and a volume flow plotted on the X-axis. Alternatively, it is also possible to plot the volume flow standardized by means of the speed of sound on the X-axis such that the representation becomes invariant. Furthermore, it is possible to provide additional set parameters in the fowl of the rotational speed or the circumferential Mach number, which have been omitted here in the interest of clarity. The set of curves comprising five curves 51-55 represent different rotational speeds or settings of the inlet guide apparatuses 11, 12, beginning with the minimum rotational speed at bottom left. Toward higher pressure ratios, the curves 51-55 of the reference stage set of characteristics Ref n are restricted by the pump limit line SL. In relation to the small pressure ratios, the measurements are restricted by the state of the complete valve opening of the choke, symbolized by means of the line 60. The current operating point 20 is situated on the middle curve 53 of the set of curves.

The measurement parameters can be ascertained, firstly by separately approaching specific operating points, secondly during the starting operation, and also, for example, during closed-loop control.

1.-14. (canceled)

15. A method for monitoring the efficiency of an at least two stage compressor, during the compression of a process medium, comprising:
monitoring a flow rate through the compressor;
monitoring an entry pressure of the drawn-in process medium;
monitoring an exit pressure of the compressed process medium;
monitoring an entry temperature of the drawn-in process medium;
monitoring an exit temperature of the compressed process medium;
using the flow rate, the entry pressure, the exit pressure, the entry temperature, and the exit temperature as a plurality of parameters;
using a calculation means to ascertain a performance factor from the plurality of parameters;
measuring a stage entry temperature and a stage entry pressure directly or indirectly as measurement parameters at an inlet of each stage;
measuring the stage exit temperature and the stage exit pressure directly or indirectly as measurement parameters at an outlet of each stage; and
assigning a module to each stage that uses the calculation means to calculate stage efficiency as a performance factor from the measurement parameters,
wherein an intermediate cooling stage is provided between the stages.

16. The method as claimed in claim 15,
wherein only one module carries out a calculation of the flow rate from at least one measurement, and
wherein the module passes on the flow rate determined to the other modules.

17. The method as claimed in claim 15,
wherein each module is designed as a software program which determines the stage efficiency for the respective stage from the measurement parameters, and
wherein each software program is executed using a computer.

18. The method as claimed in claim 15, wherein a plurality of modules include a plurality of dedicated input channels for the measurement parameters.

19. The method as claimed in claim 15, wherein the measurement parameters are stored in a memory from which each module calls the measurement parameters.

20. The method as claimed in claim 15, wherein each module calls the measurement parameters directly from a machine controller or a compressor regulator.

21. The method as claimed in claim 15, wherein the stage efficiency is determined as a polytropic stage efficiency.

22. The method as claimed in the preceding claim 21, wherein the stage efficiency is calculated as
$${η}_{pol} = \frac{1}{ν} = \frac{{{c}_{p}}^{\overline{\_}}}{R} \cdot \frac{ln \frac{{T}_{a}}{{T}_{e}}}{ln \frac{{p}_{a}}{{p}_{e}}} ,$$
and
wherein nₚₒₗ is the polytropic efficiency of stage n, ν is a polytropic ratio, C̅ₚ a specific thermal capacity averaged over a corresponding pressure and temperature ranges, R an ideal gas constant, Ta an exit temperature, Te an entry temperature, Pa an exit pressure and Pe an entry pressure, all are referred to the respective stage n.

23. The method as claimed in claim 15, wherein the stage efficiency is determined from a numerical integration of a real gas equation of state between the measurement parameters at the entry and the measurement parameters at the exit.

24. The method as claimed in claim 15,
wherein a reference stage set of characteristics is stored in a memory for each stage,
wherein an arithmetic logic unit ascertains a reference stage efficiency from the measurement parameters using the reference stage set of characteristics and forms a numerical ratio from the reference stage efficiency, and
wherein the numerical ratio is displayed on a display unit.

25. The method as claimed in claim 15, wherein the compressor is designed as a turbocompressor.

26. The method as claimed in claim 15, wherein a plurality of intermediate cooling stages are provided between the individual stages of the compressor.

27. The method as claimed in claim 15, wherein a composition of the process medium is acquired automatically using a continuous gas analysis and is an input variable for the calculation of the stage efficiency.

28. The method as claimed in claim 27, wherein the reference stage set of characteristics is determined during a calibration operation in the case of which given various guide blade positions of an inlet guide grid and/or various rotational speeds of a rotor of the compressor a pressure-side choke is closed in stepwise or continuous fashion, from being completely open, until a pump limit is reached.
